(19) United States
(12) Patent Application Publication
(10) Pub. No.: US 2025/0104330 A1
(43) Pub. Date: Mar. 27, 2025

(54) DYNAMICALLY MODIFYING RAY CAST INTERSECTION ACCELERATION STRUCTURES

(71) Applicant: GOOGLE LLC, Mountain View, CA (US)

(72) Inventor: Douglas Sim Dietrich, JR., Los Gatos, CA (US)

(21) Appl. No.: 18/725,519

(22) PCT Filed: Jan. 5, 2022
(86) PCT No.: PCT/US2022/011215

§ 371 Date: Jun. 28, 2024

(51) Int. Cl. G06T 15/06; A63F 13/52; G06T 15/50

(52) U.S. Cl. CPC G06T 15/06; A63F 13/52; G06T 15/506

(57) ABSTRACT

Systems and techniques are provided for dynamically modifying an intersection acceleration structure (IAS) used to accelerate ray cast rendering of a three-dimensional (3D) scene. A frame of the 3D scene is rendered via a set of ray casting operations performed in accordance with a first IAS, the first IAS including a plurality of bounding volumes that each includes a portion of the 3D scene. For each bounding volume, a subset of virtual light rays is tracked, the virtual light rays being associated with the set of ray casting operations and encountering the bounding volume during the rendering of the frame. Based on the subset of virtual light rays associated with each bounding volume, a modified second IAS is generated for rendering the 3D scene.

### BACKGROUND

Three-dimensional (3D) computer graphics provide users with views of 3D objects from particular viewpoints. Each object (e.g., a basketball, a building, a person, etc.) in a 3D scene may be defined using primitive geometries. For example, a cylindrical object may be modeled using three primitives: a cylindrical tube, a top circular lid, and a bottom circular lid. In certain systems and scenarios, the cylindrical tube primitive and the two circular lid primitives may each be represented by a network or mesh of smaller polygons (e.g., triangles).

Although 3D objects in computer graphics may be modeled in three dimensions, they are typically presented to viewers via one or more rectangular two-dimensional (2D) displays, such as a computer or television monitor. Such modeling and presentation results in certain portions of a 3D object being visible to a human viewer of such a display, while other portions would be hidden from view, such as by one or more intervening objects. Thus, for each 3D scene, a graphical rendering system may only need to render portions of the scene that are visible to the user, often allowing the graphical rendering system to significantly reduce an amount of computational resources or other resources associated with the presentation of the scene.

### BRIEF SUMMARY OF EMBODIMENTS

Embodiments are described herein in which an intersection acceleration structure (IAS) used to accelerate ray cast rendering of a first frame of a three-dimensional (3D) scene is dynamically modified for use in ray cast rendering one or more subsequent frames. The first frame of the 3D scene is rendered via a first set of ray casting operations performed in accordance with a first IAS, the first IAS including a plurality of bounding volumes that each includes a respective portion of the 3D scene. For each bounding volume, a subset of virtual light rays is tracked, the virtual light rays being associated with the first set of ray casting operations and encountering the bounding volume during the rendering of the frame. Based on the subset of virtual light rays associated with each bounding volume, a modified second IAS is generated for rendering the 3D scene.

In certain embodiments, a dynamic rendering acceleration (DRA) system may include one or more processors and one or more memories coupled to the one or more processors, the one or more memories storing instructions that, when executed by the one or more processors, manipulate or otherwise cause the one or more processors to render a frame of a three-dimensional (3D) scene via a first set of ray casting operations performed in accordance with a first intersection acceleration structure (IAS), the first IAS including a plurality of bounding volumes that each may include a respective portion of the 3D scene; to determine, for each bounding volume of the plurality of bounding volumes, a subset of virtual light rays associated with the first set of ray casting operations that encounter the bounding volume during the rendering of the frame; and to generate a modified second IAS for the 3D scene based on the determined subset of virtual light rays for each of the bounding volumes.

To determine the subset of virtual light rays may include to determine a subset of virtual light rays that encounter the bounding volume but that do not encounter any rendering primitives included by the bounding volume.

To determine the subset of virtual light rays may include to track a subset of virtual light rays that encounter each respective border of the bounding volume.

The instructions further cause the one or more processors to render a subsequent frame of the 3D scene via a second set of ray casting operations performed in accordance with the modified second IAS.

The frame may be rendered as part of a gaming session, such that to determine the subset of associated virtual light rays and the generating of the modified IAS for the 3D scene may be performed in real-time for each of multiple frames rendered during the gaming session.

The instructions may further cause the one or more processors to generate a model of the bounding volumes included by the first IAS based at least in part on a quantity of virtual light rays associated with the determined subset for each bounding volume.

The modified second IAS may be based at least in part on a surface area heuristic, such that the instructions further cause the one or more processors to generate a set of weights for use with the surface area heuristic based at least in part on a normalized quantity of virtual light rays associated with the determined subset for each bounding volume.

The frame may be rendered as part of a gaming session, such that the instructions further cause the one or more processors to generate rendering instructions for rendering the 3D scene based on the modified second IAS as part of initiating the gaming session.

The first IAS may be a bounding volume hierarchy (BVH), such that to generate the modified second IAS for the 3D scene may include to generate a modified second BVH.

To generate the modified second IAS for the 3D scene may include to generate a modified second IAS that may include a distinct other plurality of bounding volumes.

In certain embodiments, a method may include rendering a frame of a three-dimensional (3D) scene via a first set of ray casting operations performed in accordance with a first intersection acceleration structure (IAS), the first IAS including a plurality of bounding volumes that each may include a respective portion of the 3D scene; determining, for each bounding volume of the plurality of bounding volumes, a subset of virtual light rays associated with the first set of ray casting operations that encounter the bounding volume during the rendering of the frame; and, based on the determining, generating a modified second IAS for rendering the 3D scene.

Determining the subset of virtual light rays may include determining a subset of virtual light rays that encounter the bounding volume but that do not encounter any rendering primitives included by the bounding volume.

Determining the subset of virtual light rays may include tracking a subset of virtual light rays that encounter each respective border of the bounding volume.

The method may further include rendering a subsequent frame of the 3D scene via a second set of ray casting operations performed in accordance with the modified second IAS.

The rendering of the frame may be performed as part of a gaming session, such that the determining of the subset of associated virtual light rays and the generating of the modified IAS for the 3D scene may be performed in real-time for each of multiple frames rendered during the gaming session.

The method may further include generating a model of the bounding volumes included by the first IAS based at least in part on the determining of a quantity of virtual light rays in the determined subset for each bounding volume.

The generating of the second IAS may be based at least in part on a surface area heuristic, such that the method further comprises generating a set of weights for use with the surface area heuristic based at least in part on a normalized quantity of virtual light rays associated with the determined subset for each bounding volume.

The rendering of the frame may be performed as part of a gaming session, such that the method further comprises generating rendering instructions for rendering the 3D scene based on the modified second IAS as part of initiating the gaming session.

The first IAS may be a bounding volume hierarchy (BVH), such that generating the modified second IAS for the 3D scene may include generating a modified second BVH.

Generating the modified second IAS for the 3D scene may include generating a modified second IAS that may include a distinct other plurality of bounding volumes.

In certain embodiments, a non-transitory computer readable medium stores a set of executable instructions, such that execution of the set of executable instructions manipulates at least one processor to perform the method(s) outlined above.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 presents a simplified model of a three-dimensional (3D) scene to be rendered via ray casting operations.

FIG. 2 illustrates an overhead representational view of an example bounding volume hierarchy for a simplified 3D scene.

FIG. 3 depicts an example bounding volume hierarchy of a simplified 3D scene as a corresponding tree structure.

FIG. 4 depicts examples of false positive boundary volume intersections in a simplified 3D scene.

FIG. 5 is a block diagram illustrating an overview of an operational routine of a dynamic rendering acceleration system in accordance with one or more embodiments.

FIG. 6 is a component-level block diagram illustrating an example of a dynamic rendering acceleration computing system in accordance with one or more embodiments.

### DETAILED DESCRIPTION

Ray casting is a technique used for determining object visibility in a 3D scene. Conventionally, virtual rays are cast from a virtual camera (representing a position of an eye of a user) through every pixel of a virtual rectangular display (also termed the view plane) into the 3D world to determine what is visible to that user based on what portions of 3D objects the rays encounter.

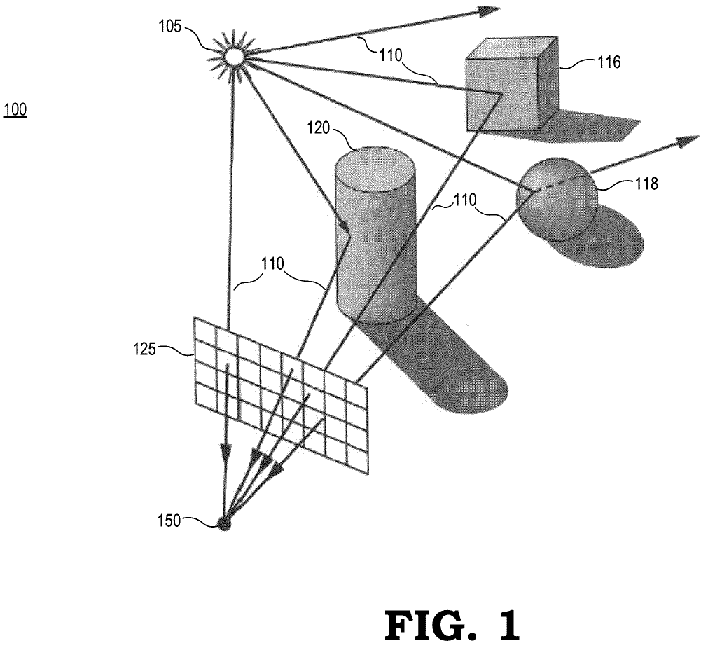

FIG. 1 presents a simplified model of a 3D scene 100 to be rendered via ray casting. A virtual light source 105 emits virtual light rays (rays) 110, some of which reflect partially or totally from one or more objects 116, 118, and 120. Rendering the 3D scene 100 via a ray casting process includes determining how each ray 110 that reaches a virtual camera 150 (via a virtual pixel grid of view plane 125) interacts with any of the objects 116, 118, and 120. A ray is cast for each pixel passing through view plane 125 in the direction illuminating the pixel. If the ray encounters an object (e.g., a primitive) the color of the pixel is assigned based on various aspects of the encountered object. For example, the assigned color may be based on a color, opacity, or other characteristic of the encountered object, as well as any light sources visible from the point of collision. The visible light sources are typically determined by tracing secondary rays shot from each light source to the point of impact. If these rays encounter an object between the light source and the point of impact, the point is in the shadow with respect to the light source.

In an unaccelerated ray casting process, determining how each ray interacts with any objects included in a 3D scene involves tracing each ray through the scene and testing the ray against every primitive in turn to find, for each ray, the ray-object intersection closest to the view plane (and therefore to the virtual eye of the user). However, doing so in this unaccelerated manner is typically inefficient for most scenes, as each individual ray typically passes nowhere near the vast majority of primitives contained in the scene as a whole. As used herein, ray-object intersection acceleration (or simply intersection acceleration) refers to methods for eliminating groups of primitives from consideration for encounters with one or more virtual rays during the rendering of a 3D scene via ray casting, thereby saving the time and computational resources associated with testing each ray against every primitive.

Generally, there are two main approaches to ray-object intersection acceleration: spatial partitioning and object partitioning. Spatial partitioning generally decomposes 3D space into regions termed bounding volumes (BVs) (e.g., by superimposing a grid of axis-aligned cuboid boxes, spheres, or other delineated partitioning shapes on the scene); in some spatial partitioning techniques, the bounding volumes may also be adaptively subdivided based on a number of primitives that overlap them. In contrast, object partitioning is based on progressively breaking the objects in the scene down into smaller sets of constituent objects, such that each set is included in a separate bounding volume. For example, a model of a room might be broken down into four walls, a ceiling, a floor, and any objects contained within the room (e.g., furniture, people, smoke, etc.). In various object partitioning techniques, each of those objects may be further partitioned into smaller sets of constituent objects, also included in a defined bounding volume. It will be appreciated that unlike in spatial partitioning, object partitioning techniques typically allow bounding volumes to nest within, and/or otherwise overlap, other bounding volumes.

Regardless of whether a 3D scene is to be rendered using ray casting operations based on spatial partitioning techniques or object partitioning techniques, intersection acceleration leverages the fact that if a ray does not encounter an edge of a bounding volume, it cannot encounter any primitive included by that bounding volume. By beneficially partitioning a 3D scene and the area and/or objects contained therein, ray cast rendering operations may be significantly accelerated by eliminating unnecessary ray-object intersection tests.

Intersection acceleration structures may be utilized to reduce significant quantities of unnecessary ray-object intersection tests by enabling a quick rejection of bounding volumes to avoid checking rays for potential encounters with primitives included therein. In certain scenarios an IAS may also enable ordering a ray-object intersection search so that nearby ray-object intersections are likely to be found earlier in the ray casting process, in order to potentially ignore ray-object intersections further from the view plane that are occluded by nearer objects. Non-limiting examples of such intersection acceleration structures include uniform grids, kD trees, octrees and bounding volume hierarchies (BVHs). In kD trees, a 3D scene is subdivided recursively and axis-parallel at an arbitrary point. Octrees are recursive in a manner similar to kD trees, but relevant cells are subdivided into 8 equal-sized rectangular cells. Bounding volume hierarchies subdivide the 3D scene into n arbitrary or pseudo-arbitrary bounding volumes surrounding a quantity of partitioned objects and/or primitives. Regardless of the particular technique utilized for partitioning a 3D scene, in certain embodiments the resulting subdivision of the space may be stored in a recursive data structure (e.g., a binary tree or other node tree).

It will be appreciated that although various examples are provided herein in which the exemplified technique is described as using one or more bounding volume hierarchies as the selected intersection acceleration structure, in various embodiments any other IAS may be used in accordance with the described techniques. Moreover, in certain embodiments a combination of such acceleration structures may be used. For example, in certain embodiments different types of intersection acceleration structures may be utilized for ray cast rendering a 3D scene based on one or more defined criteria (such as criteria regarding bounding volumes to be used in the ray cast rendering process).

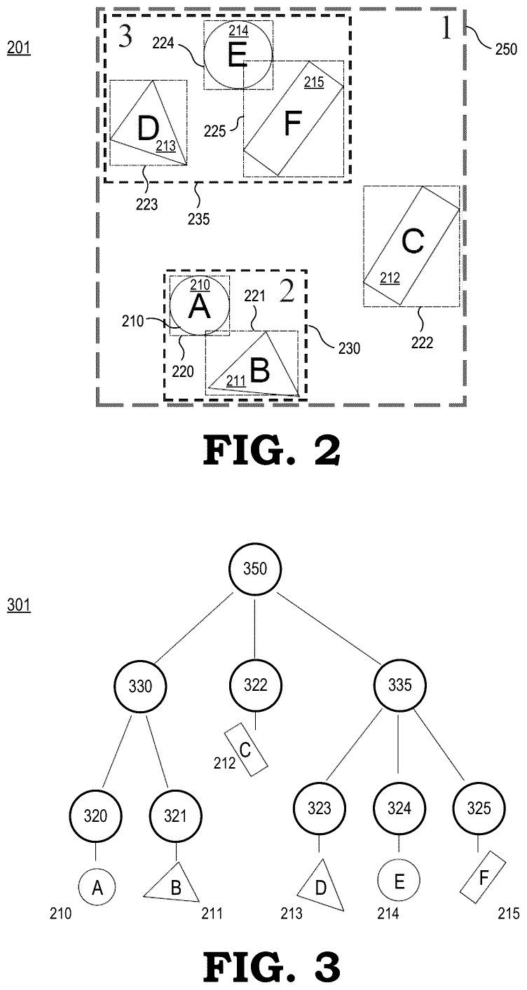

FIG. 2 illustrates an overhead representational view of an example bounding volume hierarchy for a simple scene 201. A small collection of primitives A-F (respectively identified as primitive 210, 211, 212, 213, 214, and 215) is depicted, each with a respective bounding volume 220, 221, 222, 223, 224, and 225. In the depicted bounding volume hierarchy, the primitives are further aggregated based on proximity: an aggregated proximity-based bounding volume 230 includes A and B (primitives 210 and 211), while a second aggregated proximity-based bounding volume 235 includes D, E, and F (primitives 213, 214, and 215). In addition, a bounding volume 250 encompasses the entire scene 201.

For ease of discussion, in the example of FIG. 2 and various other examples described herein each of the illustrated objects is a primitive that is wholly contained within one or more bounding volumes. However, modern ray cast rendering typically involves large quantities (e.g., billions or even trillions) of primitives-such that a single user-perceived object may also comprise large quantities of such primitives. Accordingly, ray cast rendering a 3D scene may utilize intersection acceleration structures that include thousands of bounding volumes, some of which may subdivide that single user-perceived object. For example, an IAS used for rendering a scene that includes a car may subdivide that car across many bounding volumes, regardless of whether the IAS is based on object partitioning techniques or spatial partitioning techniques. In a similar manner, it will be appreciated that while examples described herein may utilize rectangular and/or cuboid boxes as illustrative bounding volumes, in various embodiments and scenarios other bounding volume geometries (e.g., spheres, cubes, etc.) may be utilized.

FIG. 3 depicts the example bounding volume hierarchy for the scene 201 of FIG. 2 as a corresponding tree structure 301. The root node 350 corresponds to and stores the bounding volume 250, which includes each other bounding volume and object in the scene. Here, the root node has three children: node 330 corresponds to and stores bounding volume 230; node 322 corresponds to and stores the bounding volume 222; and node 335 corresponds to and stores bounding volume 235. As with the corresponding bounding volumes depicted in the example of FIG. 2, in the example tree structure 301 each of the nodes 320, 321, 322, 323, 324, and 325 have a single child node respectively storing A-F (primitives 210, 211, 212, 213, 214, and 215).

Thus, in the node tree representation of the bounding volume hierarchy, primitives are stored in the leaves, and each node stores a bounding box of the primitives in the nodes beneath it. As a ray traverses through the tree during a ray cast rendering process, any time the ray does not encounter a node's bounding volume, the subtree beneath that node can be skipped, avoiding the time and computational resources that would otherwise be used in checking for ray-object intersections with primitives stored anywhere in that subtree. Improved ray cast rendering operations are achieved when the search for ray-object intersections has to traverse fewer paths down the node tree.

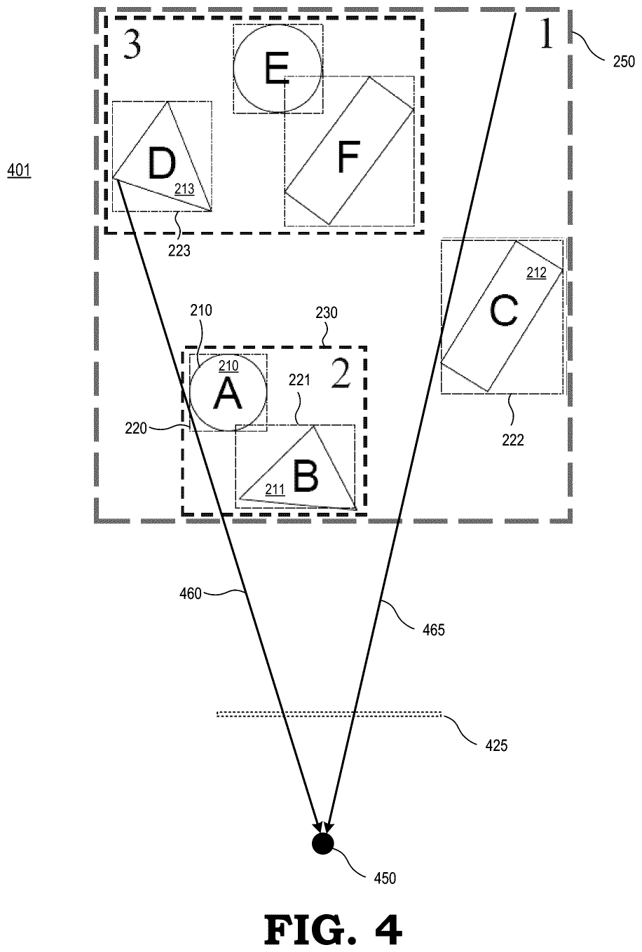

As noted above, intersection acceleration leverages the fact that if a ray does not encounter an edge of a bounding volume, it cannot encounter any primitive included by that bounding volume. However, rendering time and computational resources are often still inefficiently expended via ‘false positives’—that is, instances in which a ray encounters a border of a bounding volume but nonetheless fails to encounter any primitives included in that bounding volume, as illustrated in FIG. 4.

FIG. 4 depicts examples of false positive boundary volume intersections in the scene 201. A virtual camera 450 receives rays 460 and 465 via the pixel grid of a view plane 425. Notably, although ray 460 intersects the borders of bounding volumes 220 and 230, it does not actually encounter either of the primitives 210 and 211 respectively contained in one or both of those intersected bounding volumes. Similarly, although ray 465 intersects the borders of bounding volume 222, it does not actually encounter primitive 212 contained in that bounding volume. Thus, during a ray cast rendering process, time and computational resources will be expended by futilely checking ray 460 for ray-object intersections with primitives 210 and 211 based on that ray's intersection with bounding volumes 220, 221, and 230, and will similarly be expended by futilely checking ray 465 for ray-object intersections with primitive 212 based on that ray's intersection with bounding volume 222.

Many algorithms for building intersection acceleration structures for ray cast rendering operations are based on a “surface area heuristic” (SAH), which provides a cost model for determining which specific partitions of primitives lead to a better IAS for the purpose of minimizing ray-object intersection tests. A surface area heuristic model utilizes a surface area of each bounding volume included in a scene to estimate the computational expense of performing ray-object intersection tests, including time spent traversing nodes of the corresponding tree structure and time spent on ray-object intersection tests for a particular partitioning of primitives. In other words, an SAH model for a bounding volume hierarchy uses the surface area of each respective bounding volume as a proxy for how likely that bounding volume is to be encountered by a ray query of the overall bounding volume hierarchy. However, the SAH model assumes that each ray direction is equally likely. For example, a horizontal floor of a given surface area (e.g., the bottommost border plane of a boundary volume) is given the same weight in an SAH model as a similarly sized vertical wall, despite the fact that the likelihood of a ray encountering the floor is typically lower than hitting a wall or ceiling.

Regardless of the type of IAS used in an accelerated ray cast rendering process, such processes typically involve generating the IAS via a static algorithm—that is, the IAS is generated for a 3D scene and then used for ray cast rendering operations for each frame for which the 3D scene is to be rendered. Systems, methods, and techniques described herein can significantly reduce the occurrence of false positives during ray cast rendering of a 3D scene by dynamically modifying an intersection acceleration structure based on determining a subset of virtual light rays that encounter each bounding volume during the rendering of the frame via a first set of ray casting operations. For example, in certain embodiments, an IAS may be dynamically modified based on a respective quantity of rays in a subset of such rays that are determined to have encountered (or, alternatively, failed to encounter) at least one rendering primitive included within each respective bounding volume during rendering of an earlier frame for that 3D scene. In certain scenarios, ray cast rendering operations and other operations in accordance with techniques described herein may be performed by one or more embodiments of a dynamic rendering acceleration (DRA) system.

In various embodiments a DRA system may perform various modifications to an existing IAS in order to generate a new and/or modified IAS. As non-limiting examples, the DRA system may modify one or more respective weights for a bounding volume, such as to compensate for a SAH that otherwise would treat all ray directions as equally likely; may determine a modified orientation for an axis used to orient some or all bounding volumes in the IAS (e.g., to select between local x/y/z coordinate axes, an axis of an existing bounding volume, or an axis based on a variance or other characteristic of the axis, such as to utilize a dimension with the greatest variance in order to minimize a size of child volumes); may modify the partitioning of the objects in a scene, arriving at a plurality of bounding volumes that is distinct from that which was used to accelerate rendering of one or more previous frames (e.g., to split one or more objects at a median or mean, to reduce a sum of volumes or surface areas of one or more bounding volumes, to reduce a volume of intersection of one or more bounding volumes, and/or to increase or decrease a separation between child bounding volumes); may modify a shape or other characteristic of one or more bounding volumes (e.g., to select between cubic, cuboid, spherical, or other BV shape); may modify a sequence of traversal through the IAS (e.g., to select breadth-first or depth-first traversal); etc.

In certain embodiments a DRA system may track, with respect to each bounding volume specified by an IAS used for rendering a first frame of a scene, a subset of rays that intersect a border of the bounding volume but that do not encounter any primitive included by that bounding volume—that is, a false-positive encounter with the bounding volume. As another example, in certain embodiments a rendering system may instead develop a model (e.g., a histogram, heat map, or other model) or otherwise track BV-specific information regarding a subset of rays that do actually encounter at least one primitive included by a respective BV during the rendering of a frame. In either case, the DRA system may determine to generate a modified intersection acceleration structure for use in rendering a subsequent frame of a 3D scene based on respective subsets of (including, in certain embodiments, based on tracked quantities of) virtual rays that intersect a border of a bounding volume during ray cast operations performed with respect to a previous frame—and that respectively either encounter at least one primitive contained by the bounding volume, or instead fail to do so. In at least some embodiments, one or more such models generated by the DRA system may be stored as one or more data structures, locally or remotely with respect to the generating DRA system itself.

In certain embodiments, a DRA system may develop a model or otherwise track BV-specific information across multiple frames for purposes of improving an IAS used when rendering those frames. For example, in an embodiment the DRA system may develop a histogram of false-positive ray-BV encounters over the course of rendering four frames of a 3D scene, and then generate a modified IAS based on that developed histogram.

In various embodiments, a DRA system may develop a model or otherwise track BV-specific information based on a sampled rendering of one or more frames. For example, rather than develop the model based on all rays cast during the rendering process, the DRA system may develop the model based on a sample rate for such rays, such as by performing simulated ray casts for a small finite quantity of rays for each pixel in a pixel grid of a view plane (e.g., view plane 125 of FIG. 1 or view plane 425 of FIG. 4). In such embodiments, the DRA system may generate a modified IAS for the 3D scene being rendered based only on representative samples, typically enabling faster development of the model and generation of the modified IAS for use in real-time rendering applications.

In some embodiments, the DRA system may track BV-specific information with respect to each border of each bounding volume as well. The rendering system may then determine, based on a subset of rays associated with each bounding volume and/or its borders, to generate a modified IAS for use in rendering one or more subsequent frames of the scene. In certain embodiments, determining a subset for each BV and/or BV border may include tracking a respective quantity of such false-positive rays and generating a histogram, heat map, or other model of those tracked quantities, including in certain scenarios and embodiments to generate one or more such models using normalized values representing those tracked quantities.

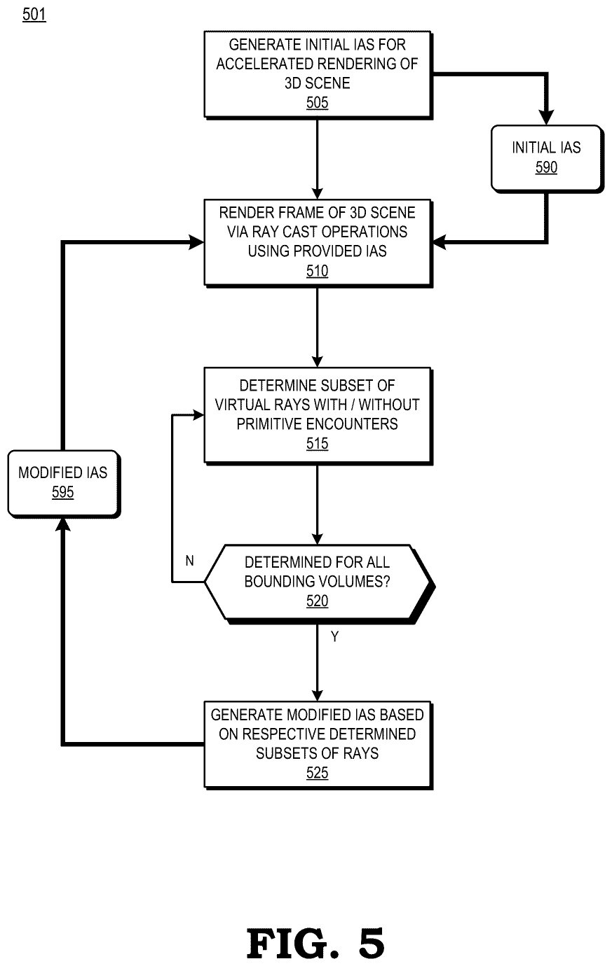

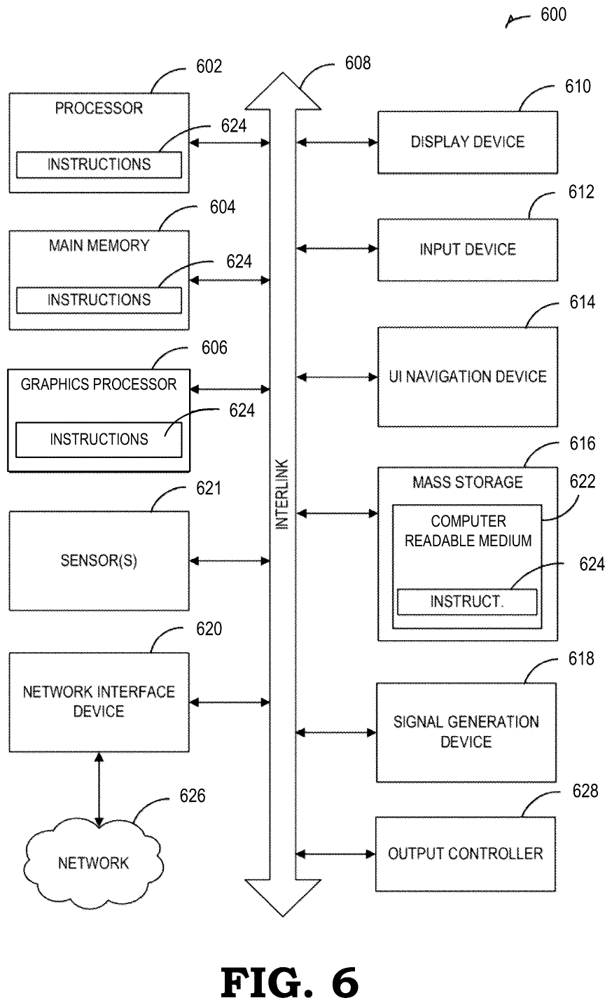

FIG. 5 is a block diagram illustrating an overview of an operational routine of a DRA system (such as the DRA computing system 600 of FIG. 6) in accordance with one or more embodiments. The routine begins at block 505, in which an initial intersection acceleration structure is generated for an accelerated rendering of a 3D scene. In certain embodiments, the initial IAS may be generated (as a non-limiting example) as part of generating instructions for an initial rendering of the scene, such as for a game level in a gaming application. After the initial IAS 590 is generated, the routine proceeds to block 510.

At block 510, a frame of the 3D scene is rendered in an accelerated manner via ray cast operations using the provided IAS as input. As discussed in greater detail elsewhere herein, in various embodiments the ray cast operations include recursively proceeding down a tree representation of a plurality of bounding volumes delineated in the provided IAS, checking for ray-object intersections for each ray and ignoring any subtrees of each node associated with a bounding volume that the ray does not encounter. The routine proceeds to block 515.

At block 515, a subset of virtual rays that encountered each respective bounding volume during the rendering of the frame is determined. As discussed elsewhere herein, in certain embodiments the determined subset is of rays that encountered a border of the bounding volume but did not encounter any primitives included in that bounding volume; in other embodiments, the determined subset may be of rays that encountered a border of the bounding volume and did encounter at least one primitive included in the bounding volume. At block 520, the routine determines whether the relevant subset of rays has been determined for all bounding volumes in the IAS provided as input for the frame rendering in block 510. If not, the routine returns to block 515, and otherwise proceeds to block 525.

At block 525, a modified IAS is generated based on the respective subsets of rays determined for each bounding volume in block 515. As described elsewhere herein, in certain embodiments the modified IAS may be generated based on tracked ray encounter data associated with the IAS used during rendering of the frame. In various embodiments, the modified IAS may be based at least in part on a surface area heuristic, such that generating the modified IAS may include generating a set of weights for use with the surface area heuristic based on the respective subset of rays determined for each respective bounding volume.

After the modified IAS 595 is generated, the routine returns to block 510, in which a subsequent frame of the 3D scene is rendered in an accelerated manner via ray cast operations using the modified IAS as input. In certain embodiments, the generation of a modified IAS may be performed after each frame is rendered, such as in real time during a gaming session or other application session. In other embodiments, the generation of the modified IAS may only be performed after a defined quantity of frames have been rendered, or in response to one or more performance characteristics for rendering of a frame (such as if a time involved in rendering a particular frame has exceeded a defined time threshold, or based on one or more other criteria). In certain embodiments, the modified IAS may be stored for future use, such as for use in generating instructions for rendering the 3D scene based on the modified IAS as part of rendering the scene during a subsequent gaming session.

FIG. 6 is a component-level block diagram illustrating an example of a DRA computing system 600 suitable for implementing one or more embodiments. In alternative embodiments, the computing system 600 may operate as a standalone device or may be connected (e.g., networked) to other systems. In various embodiments, one or more components of the computing system 600 may be incorporated as or within one or more server computing systems to provide various types of game application output or other content. It will be appreciated that an associated server computing device may include some components of computing system 600, but not necessarily all of them. In a networked deployment, the computing system 600 may operate in the capacity of a server machine, a client machine, or both in server-client network environments. In at least one example, the computing system 600 may act as a peer system in peer-to-peer (P2P) (or other distributed) network environment. The computing system 600 may be a server computer, a personal computer (PC), a tablet PC, a set-top box (STB), a mobile computing device, a web appliance, a network router, switch or bridge, or any system capable of executing instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The computing system 600 may include one or more hardware processors 602 (e.g., a central processing unit (CPU), a hardware processor core, or any combination thereof), a main memory 604, and a graphics processing unit (GPU) 606, some or all of which may communicate with each other via an interlink (e.g., bus) 608. The computing system 600 may further include a display unit 610 (such as a display monitor or other display device), an alphanumeric input device 612 (e.g., a keyboard or other physical or touch-based actuators), and a user interface (UI) navigation device 614 (e.g., a mouse or other pointing device, such as a touch-based interface). In one example, the display unit 610, input device 612, and UI navigation device 614 may comprise a touch screen display. The computing system 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The computing system 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a computer-readable medium 622 on which is stored one or more sets of data structures or instructions 624 (e.g., software) embodying or utilized by any one or more of the techniques or functions described herein. The instructions 624 may also reside, completely or at least partially, within the main memory 604, within GPU 606, or within the hardware processor 602 during execution thereof by the computing system 600. In an example, one or any combination of the hardware processor 602, the main memory 604, the GPU 606, or the storage device 616 may constitute computer-readable media.

While the computer-readable medium 622 is illustrated as a single medium, the term “computer-readable medium” may include a single medium or multiple media (e.g., a centralized or distributed database, and/or associated caches and servers) configured to store the one or more instructions 624.

The term “computer-readable medium” may include any medium that is capable of storing, encoding, or carrying instructions for execution by the computing system 600 and that cause the computing system 600 to perform any one or more of the techniques of the present disclosure, or that is capable of storing, encoding or carrying data structures used by or associated with such instructions. Non-limiting computer-readable medium examples may include solid-state memories, and optical and magnetic media. In an example, a massed computer-readable medium comprises a computer-readable medium with a plurality of particles having invariant (e.g., rest) mass. Accordingly, massed computer-readable media are not transitory propagating signals. Specific examples of massed computer-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the computing system 600, and includes digital or analog communications signals or other intangible medium to facilitate communication of such software.

In some embodiments, the apparatus and techniques described above are implemented in a system including one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs include code executable by a computer system to manipulate or otherwise cause the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate or otherwise cause the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A system, comprising:
one or more processors; and
one or more memories coupled to the one or more processors, the one or more memories storing instructions that, when executed by the one or more processors, cause the one or more processors to:
render a frame of a three-dimensional (3D) scene via a first set of ray casting operations performed in accordance with a first intersection acceleration structure (IAS), the first IAS including a plurality of bounding volumes that each includes a respective portion of the 3D scene;
determine, for each bounding volume of the plurality of bounding volumes, a subset of virtual light rays associated with the first set of ray casting operations that encounter the bounding volume during the rendering of the frame; and
generate a modified second IAS for the 3D scene based on the determined subset of virtual light rays for each of the bounding volumes.

2. The system of claim 1, wherein to determine the subset of virtual light rays includes to determine a subset of virtual light rays that encounter the bounding volume but that do not encounter any rendering primitives included by the bounding volume.

3. The system of claim 1, wherein to determine the subset of virtual light rays includes to track a subset of virtual light rays that encounter each respective border of the bounding volume.

4. The system of claim 1, wherein the instructions further cause the one or more processors to render a subsequent frame of the 3D scene via a second set of ray casting operations performed in accordance with the modified second IAS.

5. The system of claim 1, wherein the frame is rendered as part of a gaming session, and wherein to determine the subset of associated virtual light rays and the generation of the modified second IAS for the 3D scene is performed in real-time for each of multiple frames rendered during the gaming session.

6. The system of claim 1, wherein the instructions further cause the one or more processors to generate a model of the bounding volumes included by the first IAS based at least in part on a quantity of virtual light rays associated with the determined subset for each bounding volume.

7. The system of claim 1, wherein the modified second IAS is based at least in part on a surface area heuristic, and wherein the instructions further cause the one or more processors to generate a set of weights for use with the surface area heuristic based at least in part on a normalized quantity of virtual light rays associated with the determined subset for each bounding volume.

8. The system of claim 1, wherein the frame is rendered as part of a gaming session, and wherein the instructions further cause the one or more processors to generate rendering instructions for rendering the 3D scene based on the modified second IAS as part of initiating the gaming session.

9. The system of claim 1, wherein the first IAS is a bounding volume hierarchy (BVH), and wherein to generate the modified second IAS for the 3D scene includes to generate a modified second BVH.

10. The system of claim 1, wherein to generate the modified second IAS for the 3D scene includes to generate a modified second IAS that includes a distinct other plurality of bounding volumes.

11. A method comprising:
rendering a frame of a three-dimensional (3D) scene via a first set of ray casting operations performed in accordance with a first intersection acceleration structure (IAS), the first IAS including a plurality of bounding volumes that each includes a respective portion of the 3D scene;
determining, for each bounding volume of the plurality of bounding volumes, a subset of virtual light rays associated with the first set of ray casting operations that encounter the bounding volume during the rendering of the frame; and
based on the determining, generating a modified second IAS for rendering the 3D scene.

12. The method of claim 11, wherein determining the subset of virtual light rays includes determining a subset of virtual light rays that encounter the bounding volume but that do not encounter any rendering primitives included by the bounding volume.

13. The method of claim 11, wherein determining the subset of virtual light rays includes tracking a subset of virtual light rays that encounter each respective border of the bounding volume.

14. The method of claim 11, further comprising:
rendering a subsequent frame of the 3D scene via a second set of ray casting operations performed in accordance with the modified second IAS.

15. The method of claim 11, wherein
the rendering of the frame is performed as part of a gaming session, and wherein the determining of the subset of associated virtual light rays and the generating of the modified IAS for the 3D scene is performed in real-time for each of multiple frames rendered during the gaming session.

16. The method of claim 11, further comprising:
generating a model of the bounding volumes included by the first IAS based at least in part on a quantity of virtual light rays associated with the determined subset for each bounding volume.

17. The method of claim 11, wherein the generating of the second IAS is based at least in part on a surface area heuristic, and wherein the method further comprises generating a set of weights for use with the surface area heuristic based at least in part on a normalized quantity of virtual light rays associated with the determined subset for each bounding volume.

18. The method of claim 11, wherein the rendering of the frame is performed as part of a gaming session, and wherein the method further comprises generating rendering instructions for rendering the 3D scene based on the modified second IAS as part of initiating the gaming session.

19. The method of claim 11, wherein the first IAS is a bounding volume hierarchy (BVH), and wherein generating the modified second IAS for the 3D scene includes generating a modified second BVH.

20. The method of claim 11, wherein generating the modified second IAS for the 3D scene includes generating a modified second IAS that includes a distinct other plurality of bounding volumes.

21. A non-transitory computer readable medium storing a set of executable instructions, the set of executable instructions to cause at least one processor to;
render a frame of a three-dimensional (3D) scene via a first set of ray casting operations performed in accordance with a first intersection acceleration structure (IAS), the first IAS including a plurality of bounding volumes that each includes a respective portion of the 3D scene;
determine, for each bounding volume of the plurality of bounding volumes, a subset of virtual light rays associated with the first set of ray casting operations that encounter the bounding volume during the rendering of the frame; and
generate a modified second IAS for the 3D scene based on the determined subset of virtual light rays for each of the bounding volumes.
